(19) United States
(12) Patent Application Publication
(10) Pub. No.: US 2010/0279198 A1
(43) Pub. Date: Nov. 4, 2010

(54) COMPOSITE POLYMER ELECTROLYTE MEMBRANES

(75) Inventors: Alex Mossman, Vancouver (CA); David Olmeijer, San Francisco, CA (US)

Correspondence Address: MORGAN, LEWIS & BOCKIUS, LLP (SF), ONE MARKET SPEAR STREET TOWER, SAN FRANCISCO, CA, 94105, US

(73) Assignee: Polyfuel, Inc., Mountain View, CA (US)

(21) Appl. No.: 12/031,675

(22) Filed: Feb. 14, 2008

Related U.S. Application Data
(60) Provisional application No. 60/890,437, filed on Feb. 16, 2007.

(51) Int. Cl. H01M 8/10

(52) U.S. Cl. 429/483; 429/492

(57) ABSTRACT

The invention provides composite polymer electrolyte membranes (PEMs) that have reduced methanol crossover and can be used to fabricate catalyst coated membranes (CCMs), membrane electrode assemblies (MEAs), and fuel cells.

### CROSS-REFERENCE TO RELATED APPLICATION

The present application claims priority to U.S. Provisional Application 60/890,437 filed Feb. 16, 2007, which is incorporated herein by reference.

### FIELD OF THE INVENTION

Composite polymer electrolyte membranes having decreased methanol permeability, methods of making such membranes and fuel cells containing them.

### BACKGROUND OF THE INVENTION

Fuel cells are promising power sources for portable electronic devices, electric vehicles and other applications due mainly to their non-polluting nature. Of various fuel cell systems, polymer electrolyte membrane (PEM) based fuel cells such as direct methanol fuel cells (DMFCs) and hydrogen fuel cells, have attracted significant interest because of their high power density and energy conversion efficiency. The “heart” of a polymer electrolyte membrane based fuel cell is the so called “membrane-electrode assembly” (MEA), which comprises a proton exchange membrane (PEM), catalyst disposed on the opposite surfaces of the PEM to form a pair of electrodes (i.e., an anode and a cathode) disposed to be in electrical contact with the catalyst layer.

Proton-conducting membranes for DMFCs are known, such as Nafion® from the E.I. Dupont De Nemours and Company or analogous products from Dow Chemical. These perfluorinated hydrocarbon sulfonate ionomer products, however, have serious limitations when used in high temperature fuel cell applications. Mafion® loses conductivity when the operation temperature of the fuel cell is over 80° C. Moreover, Nafion® has a very high methanol crossover rate, which impedes its applications in DMFCs.

A good membrane for fuel cell operations requires balancing various properties of the membrane. In methanol fuel cells such as DMFC's, such properties include maximizing proton conductivity while minimizing methanol crossover.

One approach addressing the methanol crossover problem involves the use of a barrier layer in the membrane structure to impede methanol permeation through the membrane. Such methanol barriers should have good proton conductivity and low methanol permeability. Examples of this approach include the introduction of a thin barrier layer of polybenzimidizol (PBI) on a Nafion® membrane surface by screen printing. See Hobson, et al., J. Power Sources, Boalt 104, 79 (2002). Others have deposited thin plasma polymerized barrier films onto Nafion® membranes. See Walker, et al., S., Surf. Coat Technol., 116-119, 1996 (1999) and Feichtenger, et al., Surf. Coat Technol., 142-144, 181 (2001). The resistance to methanol permeability of the modified membranes was increased by about 15-20 fold. However, the proton conductivity was about 10 times lower. A trilayer membrane containing a Nafion®-(poly)vinylidenefluoride (PVDF) blend film hot pressed between two Nafion® membranes has also been reported. See Si, et al., J. Electrochem. Society, 151, A463 (2004).

Sulfonated polyarylene membranes suffer from high methanol crossover due to membrane swelling at the higher sulfonation degrees needed for proton conductivity. Methanol crossover can be reduced by reducing the degree of sulfonation. However, this will decrease proton conductivity. This resistance to proton conductivity can be minimized by employing thinner membranes. However, a single thin membrane usually shows poor mechanical strength and can lead to mechanical failure.

In an attempt to overcome this problem, a sulfonated polyether etherketone (sPEEK) having a low sulfonation degree was hot-pressed between two Nafion® films. See Jiang, et al., B. Electrochemical Society Meeting Abstracts, Orlando Fla., Oct. 12-16, 2003, and Yang, et al., Electrochem. Commun. 6, 231 (2004).

Another approach used a solution casting procedure to make a multi-layer sPEEK membrane where a thin sPEEK layer (5-15 microns) with a sulfonation degree of 41% was positioned between layers of sPEEK having a 60% sulfonation degree to produce a PEM having an overall thickness of 50 microns. See Jiang et al., Journal of the Electrochemical Society, 153 (8) A1554-A1561 (2006). See also, Marrony, et al., Fuel Cells, 5, No. 3:412-418 (2005).

It is an object of the invention to provide multi-layer composite PEMs having reduced methanol crossover without significantly sacrificing proton conductivity.

### SUMMARY OF THE INVENTION

In one embodiment, the multilayer composite PEMs are made from two or more membranes, each made from one or more ion-conducting polymers. These membranes are sometimes referred to as ion-conducting layers (ICL's) when discussed within the context of a multi-layer composite PEM. The composite PEM is flat and is defined by planar dimensions X^{M} and Y^{M} and a thickness Z in the Z^{M} dimension perpendicular to an X^{M}, Y^{M} plane. (See FIG. 1.) In one embodiment, the composite PEM comprises first and second ion-conducting layers. The first layer is a dimensionally stabilized ICL (sometimes returned to as a DSICL) that swells anisotropically in the Z^{M} dimension as compared to its swelling in the X^{M} and/or Y^{M} dimension. (See FIG. 2.) The second layer is an ICL. The composite PEM can further comprise a third ion-conducting layer, where the third layer is a dimensionally stabilized ICL adjacent to the second layer. (See FIG. 3.)

In these embodiments, the DSICL(s) are in contact with the ICL. When contacted with fuel, such as methanol, the DSICL layer(s) swell primarily in the Z direction relative to the swelling in the plane of the layer. ICLs that are not part of the composite PEM generally swell isotropically. However, within the composite PEM, the ICL is constrained from expanding in the X, Y plane by the DSICL layer(s). Because of this restraint, the ICL acts as a barrier to reduce fuel transport across the composite PEM.

The composite PEM can also include a fourth layer comprising an ICL, where the fourth layer is inconsistent with the third layer (See FIG. 4) and optionally a fifth layer comprising a DSICL, where the fifth layer is in contact with the fourth layer (See FIG. 5).

The composite PEM preferably is between 20 and 65 microns thick. The ICL preferably has a thickness of 5 microns or less, while the DSICL has a thickness generally greater than 10 microns.

In some embodiments, the ICL has a lower ion exchange capacity (IEC) than the IEC of the DSICL layers. Accordingly, in this embodiment, at least one of the second layer and fourth layer, if present, has a lower ion exchange capacity (IEC) than the IEC of at least one of the first, third and fifth layers, if present. Alternatively, at least one of the second and fourth layers can have a higher IEC than the IEC of at least one of the first, third and fifth layers.

In another embodiment, the composite PEM comprises in order first, second, and third ion conducting layers where the second layer is a DSICL (See FIG. 6).

In an alternative embodiment, a composite PEM comprises first and second ion conducting layers, where the second layer has a thickness less than 5 microns and a lower ion exchange capacity (IEC) than the first layer. Generally, the first layer has a thickness of 30 microns or less. In addition, a third ICL can be added so that the second layer is between the first and the third layers. In this embodiment, the thickness of the composite PEM is preferably less than 50 microns.

A surface of the composite PEM can be coated with a catalyst layer to form a catalyst coated membrane (CCM). A catatlyst layer can also be applied to the opposite surface of the composite PEM.

The composite PEMs can also form part of a membrane electrode assembly and a fuel cell. Such fuel cells can be used in electronic devices, power supplies, electric motors and vehicles.

### BRIEF DESCRIPTION OF THE DRAWING

FIG. 1 defines the dimensions of a typical PEM. The width of a membrane is measured in the X^{M} dimension. If the sheet is long, as in a web process, X^{M} will equal the width of a roll of the sheet. The length of the sheet is measured in the Y^{M} dimension. The thickness of the sheet is measured in the Z^{M} dimension.

FIG. 2 is a cross-section of a composite PEM. The first layer is made up from a dimensionally stabilized ion-conducting layer (DSICL) and a second layer is made up from an ion-conducting polymer (ICL) to form an ion-conducting layer. The thickness of the PEM is defined by the dimension Z.

FIG. 3 shows a cross-section of a composite PEM having three layers. The first layer is a dimensionally stabilized ion-conducting layer. The second layer is an ion-conducting layer while the third layer is a dimensionally stabilized ion-conducting layer.

FIG. 4 shows a cross-section of a composite PEM having four layers. The first layer is a dimensionally stabilized ion-conducting layer as is the third layer. The second and fourth layers are ion-conducting layers.

FIG. 5 discloses a cross-section of a composite PEM having five layers. The first, third and fifth layers are dimensionally stabilized ion-conducting layers while the second and fourth layers are ion-conducting layers.

FIG. 6 is a cross-section of a composite PEM having three layers. The first and third layers are ion-conducting layers while the second layer is a dimensionally stabilized ion-conducting layer.

FIG. 7 depicts the hot pressing of a swollen membrane to form a PEM with improved dimensional stability.

FIG. 8 depicts the relationship between membrane water content and the Tg of the membrane.

FIG. 9 depicts a devise for stretching a continuous PEM web containing a region containing pull rollers and a region containing a tenter.

FIG. 10 depicts a devise to restrain opposing edges of a membrane.

FIG. 11 depicts a device for radially restraining and/or stretching a PEM

FIGS. 12A and 12B depict one method for making a composite PEM. In FIG. 12A, an ion-conducting polymer is coated onto the surface of substrate 2 to form ion-conducting layer 4. An ion-conducting polymer is also coated onto substrate 6 to form a second ion-conducting layer 8. Ion-conducting layers 4 and 8 are placed in contact with each other and the entire structure is hot pressed to form a composite PEM made up of ion-conducting layers 4 and 8. In FIG. 12B, a third ion-conducting layer 12 is shown on substrate 10. Ion-conducting layer 12 is placed in contact with ion-conducting layer 8 and the entire structure is hot pressed to form composite PEM 14 made up of ion-conducting layers 4, 8 and 12. The ion-conducting layers can be chosen so that one or more layers can be a dimensionally stabilized ion-conducting layer or an ion-conducting layer (dimensionally standardized or not) that has an IEC that is different from one or more other layers in the composite PEM.

FIG. 13 is a plot of membrane resistance versus current for a number of hydrocarbon membranes. The dots represent measurements for membranes without multilayer structure. The two diamonds are measurements for two different composite PEMs. For the diamond designated P2/P3/P2, the composite PEM was made of three layers as described in Example 22. The outer layers were made from an ion-conducting polymer that had a sulfonation degree of 25%. In addition, the outer layers were dimensionally stabilized prior to incorporation into the composite PEM. The inner layer was made of the same polymer but with a sulfonation degree of 30%. The diamond labeled P2/P4/P2 is the same as the other composite PEM except that the inner layer had a sulfonation degree of 50% (see Example 23).

FIG. 14 is a plot of PEM resistance versus current. The small dots represent hydrocarbon PEMs whereas the large dots represent composite PEMs that are not dimensionally stabilized. In this case, the two outer layers of the PEM have a higher IEC than the middle ion-conducting layer.

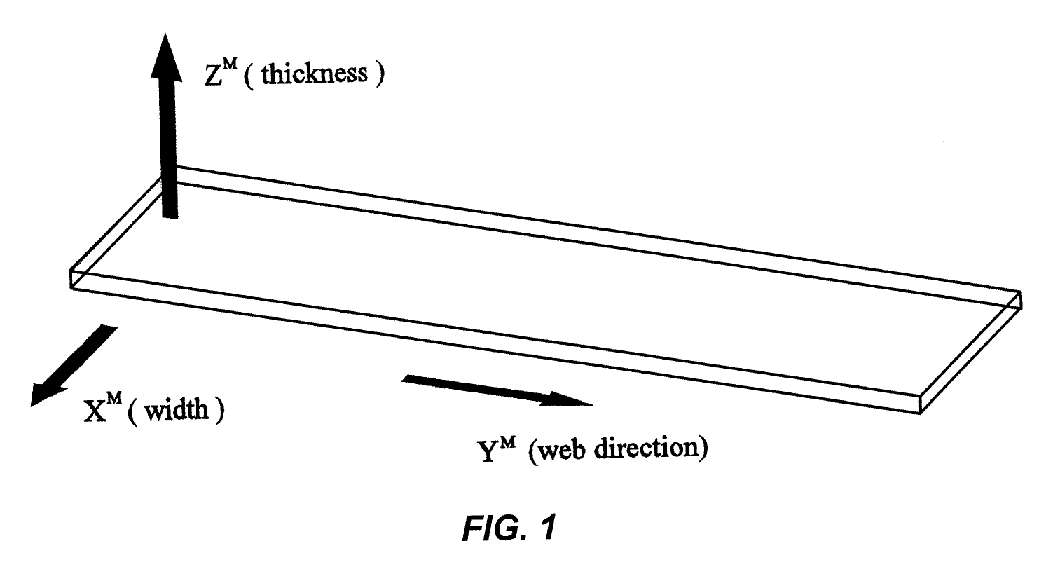

### DETAILED DESCRIPTION OF THE INVENTION

Composite PEMs are disclosed which are designed to minimize cross-over of methanol or other liquid fuels, while maximizing the proton conductivity of the composite PEM. The composite PEMs may have as few as two layers, but preferably have three or more. There are two basic approaches which can be used separately or in combination.

In the first approach, one or more dimensionally stabilized ion-conducting layers are used in combination with ion-conducting layers that have not been dimensionally stabilized to form a composite PEM.

In the second approach, ion-conducting layers having different ion exchange capacity (IEC) are used to provide a layer with a relatively low IEC to provide a barrier to methanol crossover. The low IEC layer is relatively thin to minimize the resistance to proton conductivity.

When the two approaches are combined, the composite PEM is made of one or more dimensionally stable ion-conducting layers and one or more ion-conducting layers where one or more of either the ion-conducting layer(s) or the dimensionally stabilized ion-conducting layer(s) can have a lower IEC as compared to one or more other layers in the composite PEM.

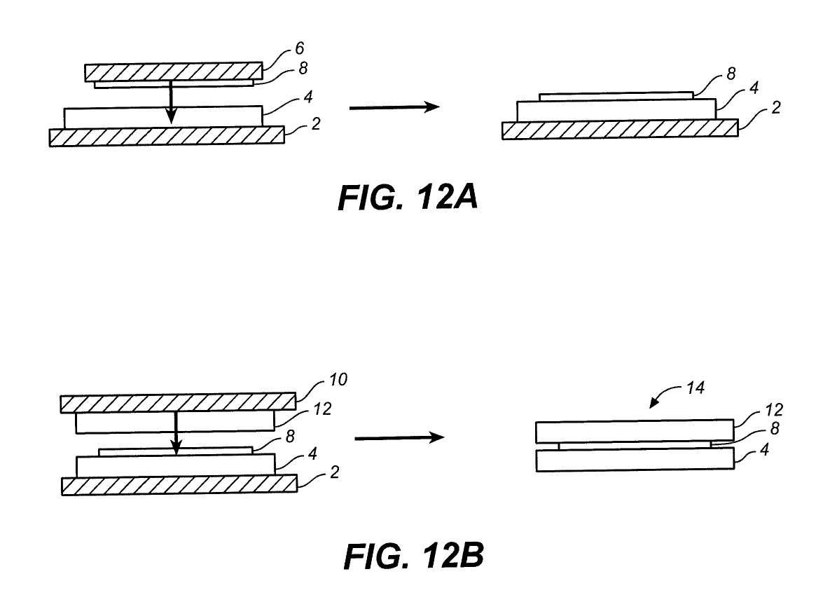

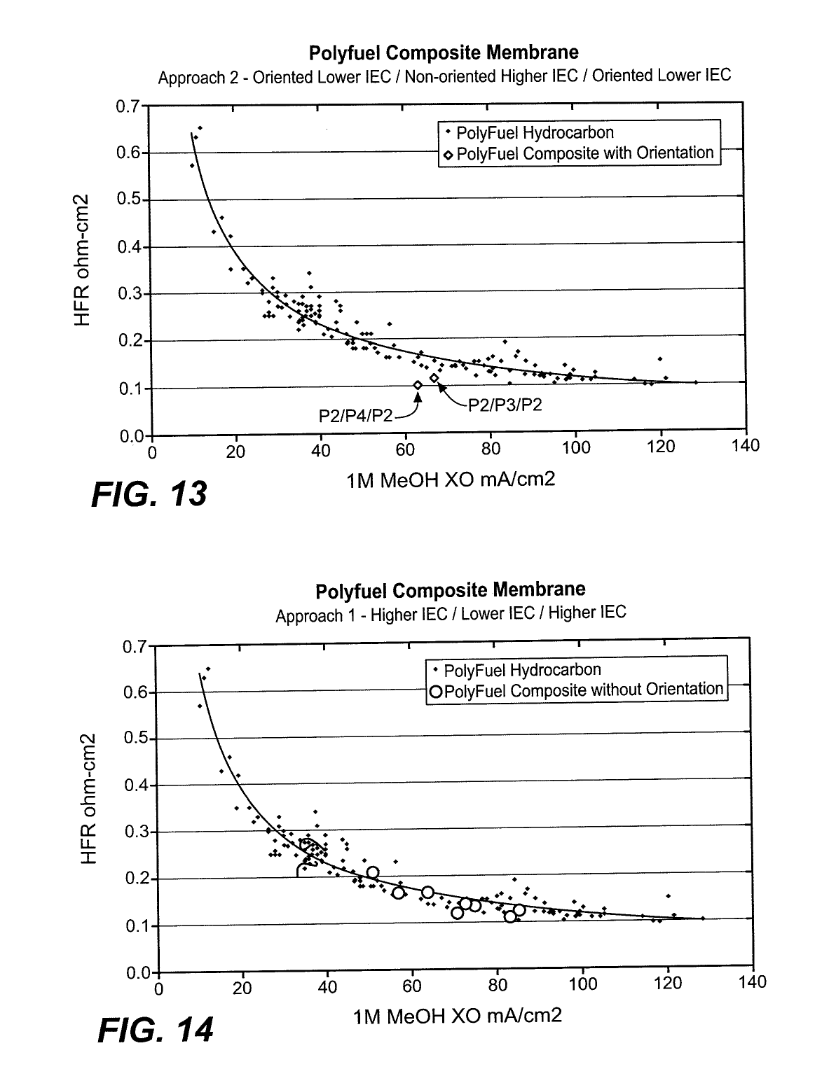

The composite PEMs can be made as described in FIG. 12A and 12B. Any ion-conducting polymer can be used to make the composite PEM. The preferred ion-conducting polymers are set forth below. The ion-conducting layers generally have well-defined IECs and may be used as is to make the composite PEM or be treated as described below to form a dimensionally stabilized ion-conducting layer. In one embodiment using DSICLs, either of the ICL layers and DSICL layers have the same ion exchange capacity. Generally, this IEC ranges from 0.5 to 3.0 meq per gram, more preferably from 0.7 to 2.0 meq per gram and most preferably from 0.9 to 1.5 meq per gram.

If layers having different ion exchange capacity layers are used and one or more is a DSICL, it is preferred that the ion-conducting layer has a greater IEC as compared to the IEC of the DSICL. When this is the case, the difference between the ion exchange capacity for one layer as compared to any of the other layers is preferably from about 0.01 to 2.5 meq per gram and more preferably from about 0.1 to 1.0 meq per gram, most preferably from 0.25 to 0.6 meq per gram.

When DSICLs are not used, the ion-exchange capacity for each of ion-conducting layers is preferably from 0.4 to 3.0 meq per gram, more preferably from 0.45 to 2.0 meq per gram, most preferably from 0.5 to 1.5 meq per gram.

When DSICLs are not used and at least two layers have different IECs, one of the interior ICLs has an IEC that is lower than the IEC for one of the other ICLs. In this case, the difference between IECs is preferably from 0.01 to 2.5 meq per gram, more preferably from 0.1 to 1.0 meq per gram, most preferably from 0.25 to 0.6 meq per gram.

### DEFINITIONS

Dimensionally stable ion-conduction layers (DSICL's) are made by processing an ion conducting layer (ICL) to convert it into a DSICL that has dimensional stability in the plane of the layer. Such DSICL's anisotropically swell in the direction perpendicular to the DSICL's plane to a greater extent as compared to the swelling in at least one dimension in the ICL plane.

As used herein, “swelling” of a ICL occurs when water or another liquid is absorbed by the ICL causing an increase in volume. As used herein, “anisotropic swelling” refers to a swelling in one dimension which is different from the swelling over the other dimension(s). As used herein, “isotropic swelling” refers to equal or nearly equal swelling in all dimensions.

As used herein, a membrane is permeable to protons if the proton flux is greater than approximately 0.005 S/cm, more preferably greater than 0.01 S/cm, most preferably greater than 0.02 S/cm.

As used herein, a membrane is “substantially impermeable” to methanol if the methanol transport across a membrane having a given thickness is less than the transfer of methanol across a Nafion membrane of the same thickness. In preferred embodiments the permeability of methanol is preferably 50% less than that of a Nafion membrane, more preferably 75% less and most preferably greater than 80% less as compared to the Nafion membrane.

Dimensionally Stable Ion-Conducting Layers

The methods of making a DSICL's use: (1) an isotropically swollen ICL or (2) a dried ICL. In each case, the ICL is subjected to strain in at least one direction in the ICL plane.

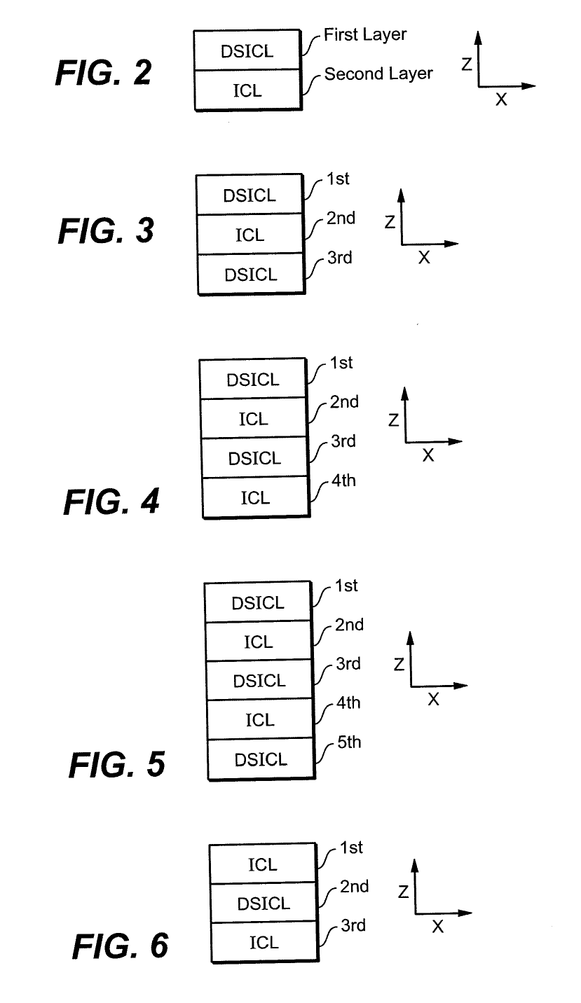

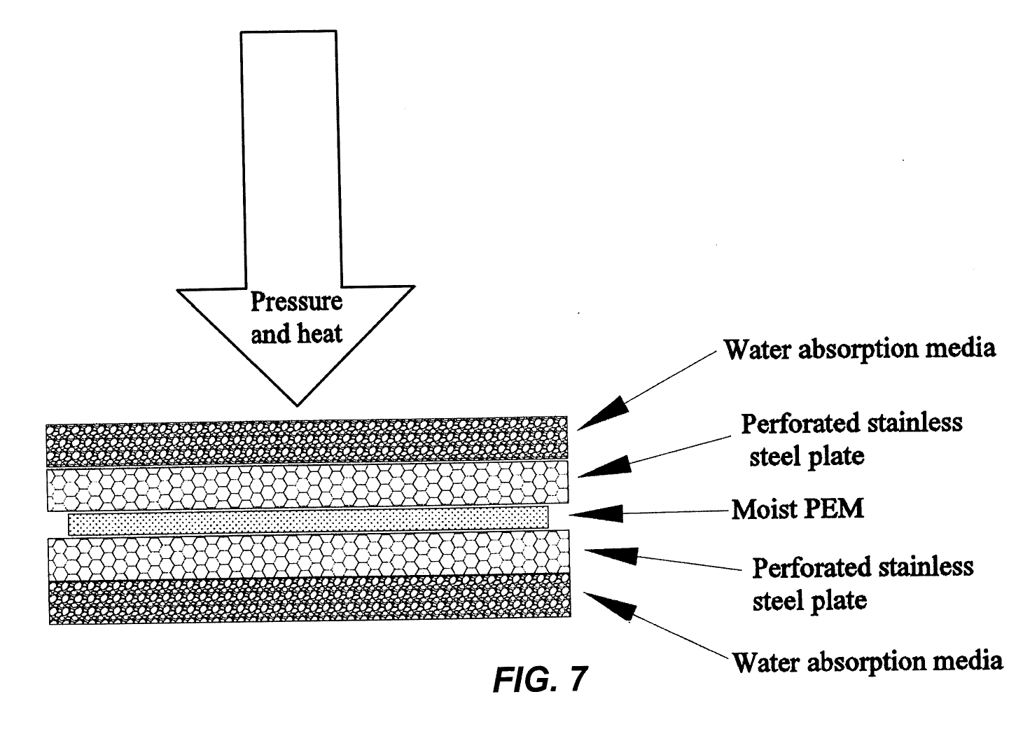

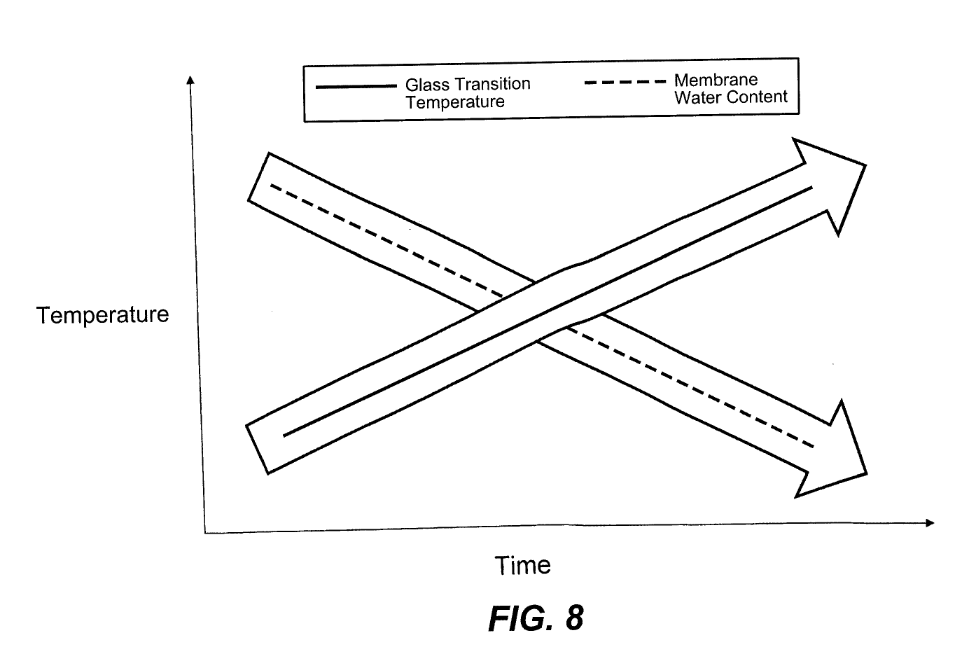

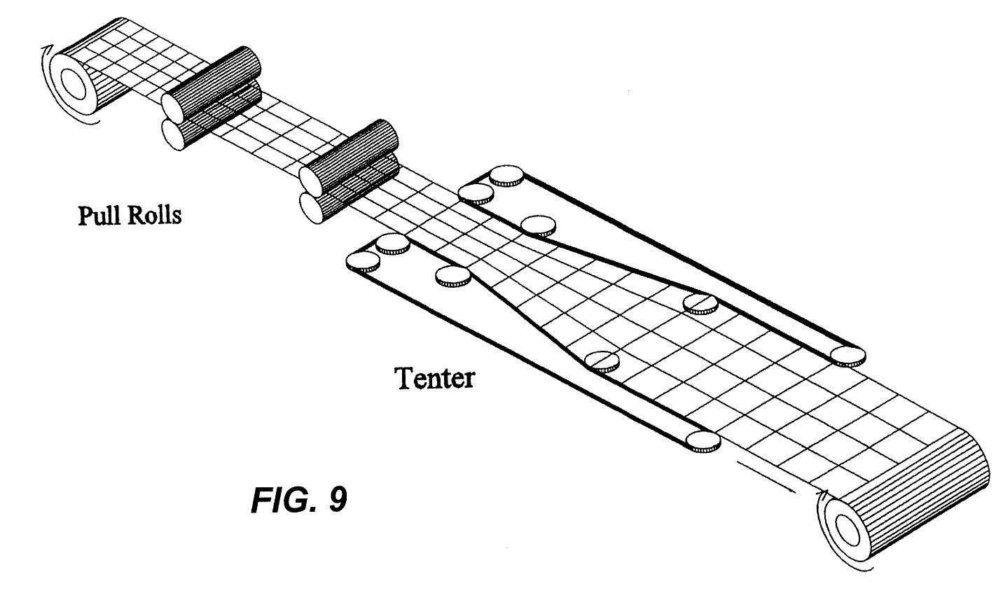

The strain can be produced by physically stretching an isotropically swollen ICL before or during drying. A devise for stretching an ICL web is shown in FIG. 2. The pull rolls in FIG. 2 stretch the membrane lengthwise in the Y^{M} dimension. The tenter section of the devise stretches the ICL across its width X^{M} . In this case the strain is produced in substantially perpendicular directions in the ICL's X^{M}, Y^{M} plane. Alternatively, one of the pull rolls or tenter can be used to stretch the ICL in the X^{M} or Y^{M} dimension. The ICL can be a dry ICL or a swollen ICL that is dried during or after the stretching. The stretching and optionally drying of the ICL in, for example the X^{M} dimension, results in a DSICL that does not significantly swell in that dimension as compared to the Z^{M} dimension. When stretched in the X^{M} and Y^{M} dimension and optionally dried, the DSICL does not significantly swell in either the X^{M} or Y^{M} dimension as compared to the Z^{M} dimension.

Alternatively, the swollen ICL can be physically restrained and then dried. In this case the tendency of the ICL to shrink in plane during the drying process produces the strain. The restraint can be produced by: (1) restraining one or more opposing edges of the ICL; (2) forming the ICL on a support to which the ICL adheres during drying; or (3) hot pressing the ICL.

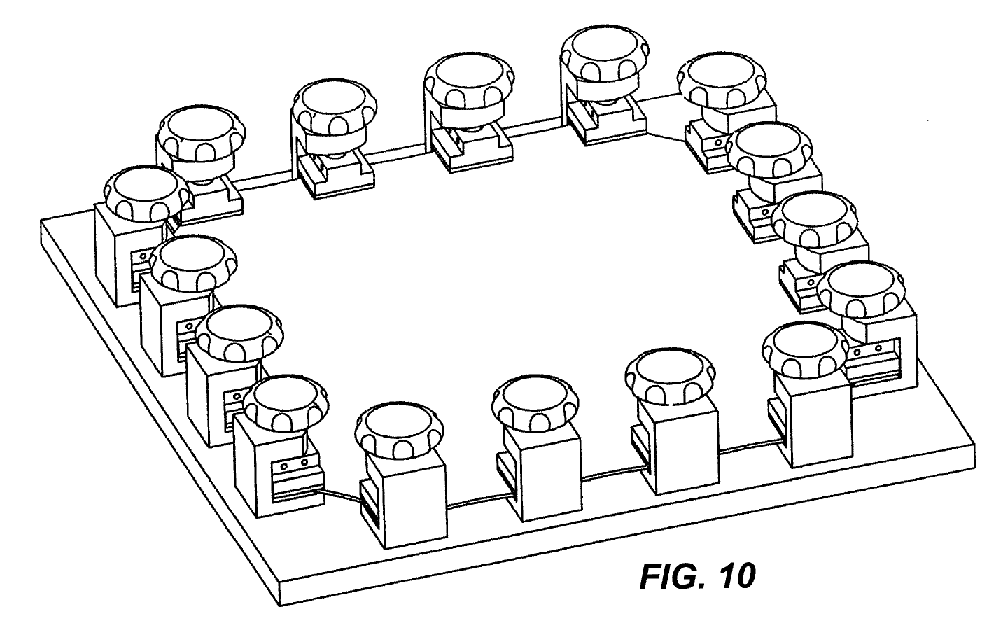

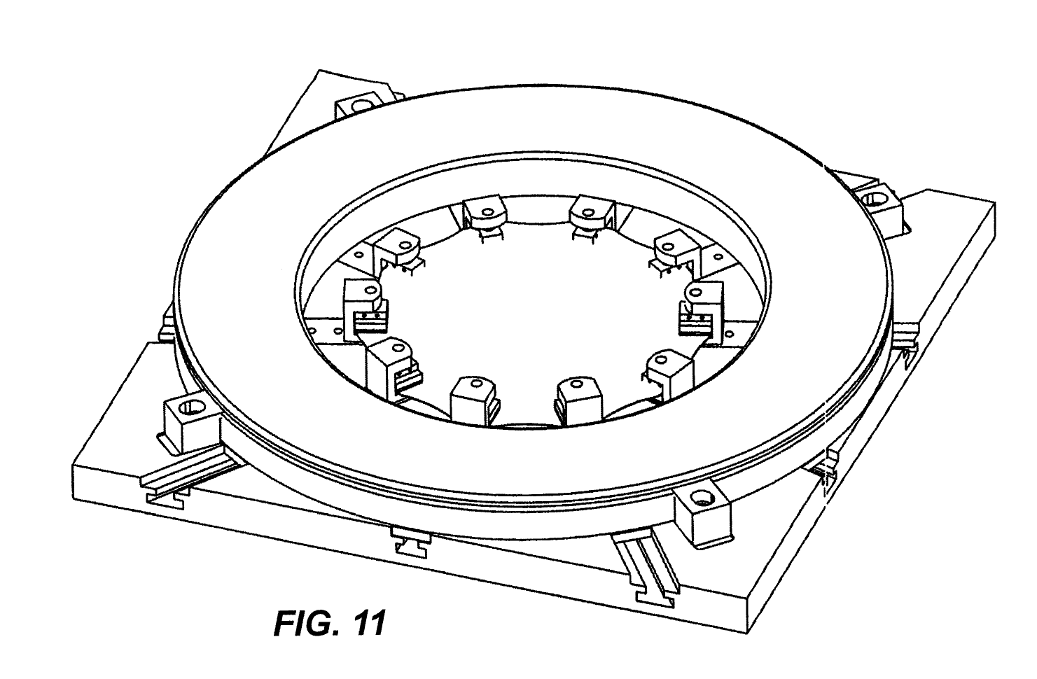

Devises such as those set forth in FIG. 10 or FIG. 11 can be used to physically restrain the ICL. In FIG. 10, a square ICL is restrained along all four edges and dried. This ICL does not significantly swell in either the X^{M} or Y^{M} dimension as compared to the Z^{M} dimension. The devise in FIG. 11 contains a plurality restraining members radially positioned about a central point. Pairs of the restraining members can be positioned opposite to each other. In FIG. 10, four pairs of opposing restraining members are radially positioned 45 degrees form the adjacent restraining pair. The devise of FIG. 10 can be used to restrain the ICL during drying and/or stretch it in one or more directions.

Restraint can also be imposed by casting the ICL on a support and allowing the ICL to dry. The support is chosen so that it will be sufficiently adherent to the cast ICL so that it restrains the ICL from substantial shrinking during the drying process. Such supports are preferably flexible to facilitate removal of the dried ICL from the support and have a thickness of between 1 mil and 10 mil. Examples of ICL supports include polyethylene teraphthalate (PET), silicon rubber and others know to those skilled in the art.

The swollen ICL can also be hot pressed. The ICL has first and second opposing planar surfaces that are hot pressed with heated members, preferably perforated members, to restrain the ICL from shrinking in plane during the drying of the ICL. In the hot pressing, at least the first surface of the swollen ICL is contacted with a first perforated member having first and second faces. The first face is in contact with all or part of the first surface of the ICL while the second face of the perforated member and/or its perforations are optionally in contact with an absorbent material. The DSICL so formed has unique in-plane dimensional stability as demonstrated by its anisotropic swelling when exposed to water, methanol or a mixture of both.

The method can also include the use of a second perforated member having first and second faces, where the first face is contacted with the second surface of the ICL. The second face of the perforated member and/or its perforations can optionally be in contact with an adsorbent material.

In some embodiments, the perforated member is a perforated cylinder and the hot pressing is of a continuous web of swollen ICL.

The hot pressing is carried out at a temperature above the Tg of the swollen ICL and less than the Tg of the ICL when dried. The hot pressing is carried out at a pressure of between 10 and 50 kg/cm2. After hot pressing, the ICL is cooled, preferably at a rate of at least 15° C./second.

The DSICL contains islands on the surfaces that had been in contact with the perforated member. These islands are in a predetermined pattern that is defined by the perforations in the hot press member. The islands typically have a height of 1 micron or less. These islands provide the additional advantage of increasing the surface area of the DSICL. This can result in enhanced bonding of the DSICL to other ICL's in the composite PEM.

The swollen ICL in each of the foregoing methods can contain a non-aqueous solvent, water or a combination of both. Alternatively, the swollen ICL can be washed with water prior to treatment to form a hydrated ICL that is substantially free of the casting solvent.

The membrane is usually dried at high temperatures (80° C. to 170° C.) until the membrane changes from clear/transparent to yellow or the desired water content is obtained to form a dried ICL. Exposure to 100° C. for 10-20 minutes typically brings down the water content to <5% by weight. A relatively dry ICL with <5% water by weight can be obtained at 150° C. in less than 4 minutes. It is preferred that the ICL only contain water as a solvent during the drying process. DMAc is not preferred for temperature greater than 80° C., and MeOH and other alcohols do not show adverse effects. However for safety reasons it is preferred that the ICL be washed in water.

A dried ICL is defined as membrane with water content of <5%. This content may depend on the IEC of the polymer used, normally the higher IEC polymers will retain more water in dry state. The lower IEC polymers will retain less water once dried. It is commonly accepted that this amount of water is closely held water in the membrane.

Each of the foregoing processes generally results in a thinner ICL which would otherwise be formed. For example, a typical dried ICL that is about 62 microns thick can swell to approximately 80 microns. When dried, the ICL returns to its original thickness. However, when the ICL is treated to form a DSICL, the same ICL which is 80 microns thick when swollen will typically have a thickness of about 45 microns after treatment and drying according to the methods of the invention. The methanol permeability and proton conductivity (and other properties besides swelling) are essentially unchanged after these processes.

Ion Conducting Polymers

The ion-conductive copolymers can comprise any ion conducting polymer or a blend of ion conducting polymer and non-ionic polymer. The ion-conducting polymer is preferably a copolymer comprising or more ion-conductive monomers and/or oligomers. Alternatively, the ion conducting polymer is a copolymer comprising one or more ion conducting oligomers distributed in a polymeric backbone where the polymeric backbone contains at least one, two or three, preferably at least two, of the following: (1) one or more ion conductive monomers, (2) one or more non-ionic monomers and (3) one or more non-ionic oligomers. The ion conducting oligomers, ion-conducting non-ionic monomers and/or non-ionic oligomers are covalently linked to each other by oxygen and/or sulfur.

In a preferred embodiment, the ion-conducting oligomer comprises first and second comonomers. The first comonomer comprises one or more ion-conducting groups. At least one of the first or second comonomers comprises two leaving groups while the other comonomer comprises two displacement groups. In one embodiment, one of the first or second comonomers is in molar excess as compared to the other so that the oligomer formed by the reaction of the first and second comonomers contains either leaving groups or displacement groups at each end of the ion-conductive oligomer. This precursor ion-conducting oligomer is combined with at least two of: (1) one or more precursor ion conducting monomers; (2) one or more precursor non-ionic monomers and (3) one or more precursor non-ionic oligomers. The precursor ion-conducting monomers, non-ionic monomers and/or non-ionic oligomers each contain two leaving groups or two displacement groups. The choice of leaving group or displacement group for each of the precursor is chosen so that the precursors combine to form an oxygen and/or sulfur linkage.

The term “leaving group” is intended to include those functional moieties that can be displaced by a nucleophilic moiety found, typically, in another monomer. Leaving groups are well recognized in the art and include, for example, halides (chloride, fluoride, iodide, bromide), tosyl, mesyl, etc. In certain embodiments, the monomer has at least two leaving groups. In the preferred polyphenylene embodiments, the leaving groups may be “para” to each other with respect to the aromatic monomer to which they are attached. However, the leaving groups may also be ortho or meta.

The term “displacing group” is intended to include those functional moieties that can act typically as nucleophiles, thereby displacing a leaving group from a suitable monomer. The monomer with the displacing group is attached, generally covalently, to the monomer that contained the leaving group. In a preferred polyarylene example, fluoride groups from aromatic monomers are displaced by phenoxide, alkoxide or sulfide ions associated with an aromatic monomer. In polyphenylene embodiments, the displacement groups are preferably para to each other. However, the displacing groups may be ortho or meta as well.

Table 1 sets forth combinations of exemplary leaving groups and displacement groups. The precursor ion conducting oligomer contains two leaving groups fluorine (F) while the other three components contain fluorine and/or hydroxyl (—OH) displacement groups. Sulfur linkages can be formed by replacing —OH with thiol (—SH). The displacement group F on the ion conducing oligomer can be replaced with a displacement group (eg-OH) in which case the other precursors are modified to substitute leaving groups for displacement groups or to substitute displacement groups for leaving groups.

TABLE 1
Exemplary Leaving Groups (Fluorine) and
Displacement Group (OH) Combinations

| | | Precursor Ion | |
|---|---|---|---|
| Precursor Ion | Precursor Non | Conducting | Precursor Non |
| Conducting Oligomer | Ionic Oligomer | Monomer | Ionic Monomer |
| 1) F | OH | OH | OH |
| 2) F | F | OH | OH |
| 3) F | OH | F | OH |
| 4) F | OH | OH | F |
| 5) F | F | F | OH |
| 6) F | F | OH | F |
| 7) F | OH | F | F |

Preferred combinations of precursors is set forth in lines 5 and 6 of Table 1.

The ion-conductive copolymer may be represented by Formula I:

[[—(Ar₁-T-)ᵢ-Ar₁—X—]ₐ^{m}/(—Ar₂—U—Ar₂—X—)_{b}ⁿ/[—(Ar₂—V—)ⱼ—Ar₃—X—]_{c}^{o}/(—Ar₄—W—Ar₄—X—)_{d}^{p}/] Formula I

wherein Ar₁, Ar₂, Ar₃ and Ar₄ are independently the same or different aromatic moieties, where at least one of Ar1 comprises an ion conducting group and where at least one of Ar₂ comprises an ion-conducting group;

T, U, V and W are linking moieties;

X is independently —O— or —S—;

i and j are independently integers greater than 1;

a, b, c, and d are mole fractions wherein the sum of a, b, c and d is 1, and (1) at least one or both of a and b are greater than zero and at least one or both of c and d are greater than zero; (2) a is greater than zero and at least one of c and d are greater than 0; or (3) a is zero, b is greater than zero and at least one of c and d are greater than zero; and

m, n, o, and p are integers indicating the number of different oligomers or comonomers in the copolymer.

The preferred values of a, b, c, and d, i and j as well as m, n, o, and p are set forth below.

The ion conducting copolymer may also be represented by Formula II:

[[—(Ar₁-T-)ᵢ-Ar₁—X—]ₐ^{m}/(—Ar₂—U—Ar₂—X—)_{b}ⁿ/[—(Ar₃—V—)ⱼ—Ar₃—X—]_{c}^{o}/(—Ar₄—W—Ar₄—X—)__{d}^{p}/] Formula II

wherein

Ar₁, Ar₂, Ar₃ and Ar₄ are independently phenyl, substituted phenyl, napthyl, terphenyl, aryl nitrile and substituted aryl nitrile;

at least one of Ar1 comprises an ion-conducting group;

at least one of Ar2 comprises an ion-conducting group;

T, U, V and W are independently a bond, —C(O)—,

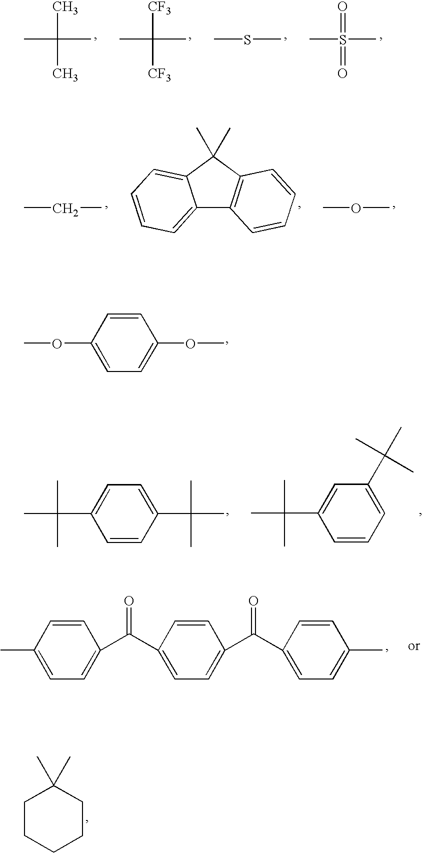

X is independently —O— or —S—;

i and j are independently integers greater than 1; and

a, b, c, and d are mole fractions wherein the sum of a, b, c and d is 1, and (1) at least one or both of a and b are greater than zero and at least one or both of c and d are greater than zero; (2) a is greater than zero and at least one of c and d are greater than 0; or (3) a is zero, b is greater than zero and at least one of c and d are greater than zero; and

m, n, o, and p are integers indicating the number of different oligomers or monomers in the copolymer.

The ion-conductive copolymer can also be represented by Formula III:

[[—(Ar₁-T-)ᵢ-Ar₁—X—]_{d}^{m}/(—Ar₂—U—Ar₂—X—)_{b}ⁿ/[—(Ar₃—V—)ⱼ—Ar₃—X—]_{c}^{o}/(—Ar₄—W—Ar₄—X—)_{d}^{p}/] Formula III

wherein

Ar₁, Ar₂, Ar₃ and Ar₄ are independently phenyl, substituted phenyl, napthyl, terphenyl, aryl nitrile and substituted aryl nitrile;

where T,U,V and W are independently a bond O, S, C(O), S(O₂), alkyl, branched alkyl, fluoroalkyl, branched fluoroalkyl, cycloalkyl, aryl, substituted aryl or heterocycle;

X is independently —O— or —S—;

i and j are independently integers greater than 1;

a, b, c, and d are mole fractions wherein the sum of a, b, c and d is 1, and (1) at least one or both of a and b are greater than zero and at least one or both of c and d are greater than zero; (2) a is greater than zero and at least one of c and d are greater than 0; or (3) a is zero, b is greater than zero and at least one of c and d are greater than zero; and

m, n, o, and p are integers indicating the number of different oligomers or monomers in the copolymer.

In each of the forgoing formulas I, II and III [—(Ar₁-T-)₁-Ar₁—]ₐ^{m} is is an ion conducting oligomer; (—Ar₂—U—Ar₂—) is is an ion conducting monomer; [(—Ar₃—V—)ⱼ—Ar₃]_{c}^{o} is a non-ionic oligomer; and (—Ar₄—W—Ar₄—)_{d}^{p} is a non-ionic monomer. Accordingly, in some cases these formulas are directed to ion-conducting polymers that include ion conducting oligomer(s) in combination with at least one of the following: (1) one or more non-ionic monomers and (2) one or more non-ionic oligomers. In other cases, the formula are directed to ion conducting polymers that include ion conducting monomer(s) in combination with at least one or more of the following: (1) one or more non-ionic monomers and (2) one or more non-ionic oligomers. In still another case, the formulas are directed to ion conducting polymers that include ion conducting monomers and ion conducting oligomers in combination with one or more of the following: (1) one or more non-ionic monomer and (2) one or non-conic oligomers.

In preferred embodiments, i and j are independently from 2 to 12, more preferably from 3 to 8 and most preferably from 4 to 6.

The mole fraction “a” of ion-conducting oligomer in the copolymer is between 0 and 0.9, preferably between 0.1 and 0.9, more preferably between 0.3 and 0.7 and most preferably between 0.3 and 0.5.

The mole fraction “b” of ion conducting monomer in the copolymer is preferably from 0 to 0.5, more preferably from 0.1 to 0.4 and most preferably from 0.1 to 0.3.

The mole fraction of “c” of non-ion conductive oligomer is preferably from 0 to 0.3, more preferably from 0.1 to 0.25 and most preferably from 0.01 to 0.15.

The mole fraction “d” of non-ion conducting monomer in the copolymer is preferably from 0 to 0.7, more preferably from 0.2 to 0.5 and most preferably from 0.2 to 0.4.

The indices m, n, o, and p are integers that take into account the use of different monomers and/or oligomers in the same copolymer or among a mixture of copolymers where m is preferably 1, 2 or 3, n is preferably 1 or 2, o is preferably 1 or 2 and p is preferably 1, 2, 3 or 4.

In some embodiments at least two of Ar₂, Ar₃ and Ar₄ are different from each other. In another embodiment Ar₂, Ar₃ and Ar₄ are each different from the other.

In some embodiments, when there is no hydrophobic oligomer, i.e. when c is zero in Formulas I, II, or III preferably: (1) the precursor ion conductive monomer used to make the ion-conducting polymer is not 2,2′ disulfonated 4,4′ dihydroxy biphenyl; (2) the ion conductive polymer does not contain the ion-conducting monomer that is formed using this precursor ion conductive monomer; and/or (3) the ion-conducting polymer is not the polymer made according to Example 3 herein.

Ion conducting copolymers and the monomers used to make them and which are not otherwise identified herein can also be used. Such ion conducting copolymers and monomers include those disclosed in U.S. patent application Ser. No. 09/872,770, filed Jun. 1, 2001, Publication No. US 2002-0127454 A1, published Sep. 12, 2002, entitled “Polymer Composition”; U.S. patent application Ser. No. 10/351,257, filed Jan. 23, 2003, Publication No. US 2003-0219640 A1, published Nov. 27, 2003, entitled “Acid Base Proton Conducting Polymer Blend Membrane”; U.S. patent application Ser. No. 10/438,186, filed May 13, 2003, Publication No. US 2004-0039148 A1, published Feb. 26, 2004, entitled “Sulfonated Copolymer”; U.S. patent application Ser. No. 10/438,299, filed May 13, 2003, entitled “Ion-conductive Block Copolymers,” published Jul. 1, 2004, Publication No. 2004-0126666; U.S. application Ser. No. 10/449,299, filed Feb. 20, 2003, Publication No. US 2003-0208038 A1, published Nov. 6, 2003, entitled “Ion-conductive Copolymer”; U.S. patent application Ser. No. 10/438,299, filed May 13, 2003, Publication No. US 2004-0126666; U.S. patent application Ser. No. 10/987,178, filed Nov. 12, 2004, entitled “Ion-conductive Random Copolymer”, Publication No.2005-0181256 published Aug. 18, 2005; U.S. patent application Ser. No. 10/987,951, filed Nov. 12, 2004, Publication No. 2005-0234146, published Oct. 20, 2005, entitled “Ion-conductive Copolymers Containing First and Second Hydrophobic Oligomers;” U.S. patent application Ser. No. 10/988,187, filed Nov. 11, 2004, Publication No. 2005-0282919, published Dec. 22, 2005, entitled “Ion-conductive Copolymers Containing One or More Hydrophobic Oligomers”; and U.S. patent application Ser. No. 11/077,994, filed Mar. 11, 2005, Publication No. 2006-004110, published Feb. 23, 2006, each of which are expressly incorporated herein by reference. Other comonomers include those used to make sulfonated trifluorostyrenes (U.S. Pat. No. 5,773,480), acid-base polymers, (U.S. Pat. No. 6,300,381), poly arylene ether sulfones (U.S. Patent Publication No. US2002/0091225A1); graft polystyrene (Macromolecules 35:1348 (2002)); polyimides (U.S. Pat. No. 6,586,561 and J. Membr. Sci. 160:127 (1999)) and Japanese Patent Applications Nos. JP2003147076 and JP2003055457, each of which are expressly identified herein by reference.

Although the polymers have been described in connection with the use of arylene polymers and copolymers, the polymers need not be arylene but rather may be aliphatic polymers or copolymers or perfluorinated aliphatic polymers or copolymers. However, in some embodiments, perflourinated polymers, such as Nafion®, are not preferred. Ion-conducting groups may also be attached to the backbone or may be pendant to the backbone, e.g., attached to the polymer backbone via a linker. Alternatively, ion-conducting groups can be formed as part of the standard backbone of the polymer. See, e.g., U.S. 2002/018737781, published Dec. 12, 2002 incorporated herein by reference. Any of these ion-conducting oligomers can be used to practice the present invention.

The following are some of the monomers used to make ion-conductive copolymers.

1) Precursor Difluoro-end monomers

| | | Molecular | |
|---|---|---|---|
| Acronym | Full name | weight | Chemical structure |
| Bis K | 4,4′-Difluorobenzophenone | 218.20 | 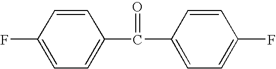 |
| Bis SO₂ | 4,4′-Difluorodiphenylsulfone | 254.25 | 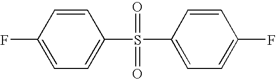 |
| S-Bis K | 3,3′-disulfonated-4,4′- difluorobenzophone | 422.28 | 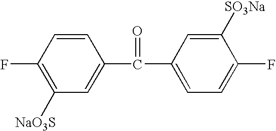 |

2) Precursor Dihydroxy-end monomers

| | | | |
|---|---|---|---|
| Bis AF (AF or 6F) | 2,2-Bis(4-hydroxyphenyl) hexafluoropropane or 4,4′-(hexafluoroisopropylidene) diphenol | 336.24 | 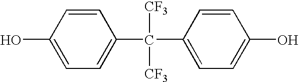 |
| BP | Biphenol | 186.21 | 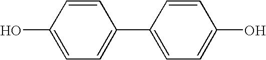 |
| Bis FL | 9,9-Bis(4-hydroxyphenyl)fluorene | 350.41 | 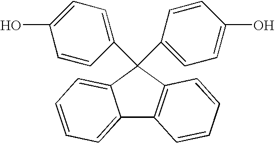 |
| Bis Z | 4,4′-cyclohexylidenebisphenol | 268.36 | 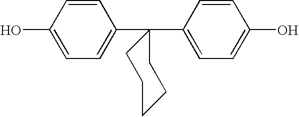 |
| Bis S | 4,4′-thiodiphenol | 218.27 | 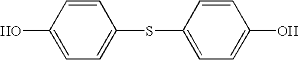 |

3) Precursor Dithiol-end monomer

| | Full | Molecular | |
|---|---|---|---|
| Acronym | name | weight | Chemical Structure |
| | 4,4′-thiol bis benzene thiol | | 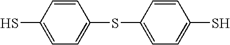 |

Formula IV is an example of a preferred random copolymer where n and m are mole fractions, where n is between 0.5 and 0.9 and m is between 0.1 and 0.5. A preferred ratio is where n is 0.7 and m is 0.3.

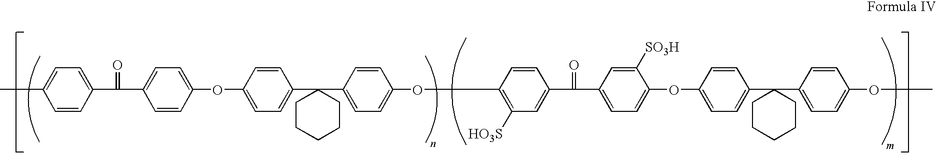

Uses of Composite Pem

After the composite PEM has been formed, it may be used to produce a catalyst coated membrane (CCM). As used herein, a CCM comprises a PEM where at least one side and preferably both of the opposing sides of the PEM are partially or completely coated with catalyst. The catalyst is preferable a layer made of catalyst and ionomer. Preferred catalysts are Pt and Pt—Ru. Preferred ionomers include Nafion and other ion-conductive polymers. In general, anode and cathode catalysts are applied onto the membrane using well established standard techniques. For direct methanol fuel cells, platinum/ruthenium catalyst is typically used on the anode side while platinum catalyst is applied on the cathode side. For hydrogen/air or hydrogen/oxygen fuel cells platinum or platinum/ruthenium is generally applied on the anode side, and platinum is applied on the cathode side. Catalysts may be optionally supported on carbon. The catalyst is initially dispersed in a small amount of water (about 100 mg of catalyst in 1 g of water). To this dispersion a 5% ionomer solution in water/alcohol is added (0.25-0.75 g). The resulting dispersion may be directly painted onto the polymer membrane. Alternatively, isopropanol (1-3 g) is added and the dispersion is directly sprayed onto the membrane. The catalyst may also be applied onto the membrane by decal transfer, as described in the open literature (Electrochimica Acta, 40: 297 (1995)).

MEAs comprise the aforementioned dimensionally stable membranes. In some embodiments, CCMs are used to make MEAs. In some embodiments, anode and cathode electrodes are positioned to be in electrical contact with the catalyst layer of the CCM.

The electrodes are in electrical contact with the catalyst layer, either directly or indirectly via a gas diffusion or other conductive layer, so that they are capable of completing an electrical circuit which includes the CCM and a load to which the fuel cell current is supplied. More particularly, a first catalyst is electro-catalytically associated with the anode side of the PEM so as to facilitate the oxidation of hydrogen or organic fuel. Such oxidation generally results in the formation of protons, electrons and, in the case of organic fuels, carbon dioxide and water. Since the membrane is substantially impermeable to molecular hydrogen and organic fuels such as methanol, as well as carbon dioxide, such components remain on the anodic side of the membrane. Electrons formed from the electrocatalytic reaction are transmitted from the anode to the load and then to the cathode. Balancing this direct electron current is the transfer of an equivalent number of protons across the membrane to the cathodic compartment. There an electrocatalytic reduction of oxygen in the presence of the transmitted protons occurs to form water. In one embodiment, air is the source of oxygen. In another embodiment, oxygen-enriched air or oxygen is used.

The membrane electrode assembly is generally used to divide a fuel cell into anodic and cathodic compartments. In such fuel cell systems, a fuel such as hydrogen gas or an organic fuel such as methanol is added to the anodic compartment while an oxidant such as oxygen or ambient air is allowed to enter the cathodic compartment. Depending upon the particular use of a fuel cell, a number of cells can be combined to achieve appropriate voltage and power output. Such applications include electrical power sources for residential, industrial, commercial power systems and for use in locomotive power such as in automobiles. Other uses to which the invention finds particular use includes the use of fuel cells in portable electronic devices such as cell phones and other telecommunication devices, video and audio consumer electronics equipment, computer laptops, computer notebooks, personal digital assistants and other computing devices, GPS devices and the like. In addition, the fuel cells may be stacked to increase voltage and current capacity for use in high power applications such as industrial and residential sewer services or used to provide locomotion to vehicles. Such fuel cell structures include those disclosed in U.S. Pat. Nos. 6,416,895, 6,413,664, 6,106,964, 5,840,438, 5,773,160, 5,750,281, 5,547,776, 5,527,363, 5,521,018, 5,514,487, 5,482,680, 5,432,021, 5,382,478, 5,300,370, 5,252,410 and 5,230,966.

Composite CCMs and MEMs are generally useful in fuel cells such as those disclosed in U.S. Pat. Nos. 5,945,231, 5,773,162, 5,992,008, 5,723,229, 6,057,051, 5,976,725, 5,789,093, 4,612,261, 4,407,905, 4,629,664, 4,562,123, 4,789,917, 4,446,210, 4,390,603, 6,110,613, 6,020,083, 5,480,735, 4,851,377, 4,420,544, 5,759,712, 5,807,412, 5,670,266, 5,916,699, 5,693,434, 5,688,613, 5,688,614, each of which is expressly incorporated herein by reference.

The composite PEMs, CCMs and MEAs of the invention may also find use in hydrogen fuel cells that are known in the art. Examples include U.S. Pat. Nos. 6,630,259; 6,617,066; 6,602,920; 6,602,627; 6,568,633; 6,544,679; 6,536,551; 6,506,510; 6,497,974, 6,321,145; 6,195,999; 5,984,235; 5,759,712; 5,509,942; and 5,458,989 each of which are expressly incorporated herein by reference.

### Examples

### Example 1

A DSICL can be made by first swelling an ICL such as the random copolymer in formula IV with methanol or a methanol-water solution, followed by washing with DI (de-ionized water) to remove Methanol. The washed membrane is then hot pressed (150° C.—above hydrated Tg, 15 kg/cm2 compressive pressure, 45 sec) between two perforated stainless steel sheets that are covered with a cloth-like material. With a significant amount of water present in the membrane, the Tg (Glass Transition Temperature) is lowered and as the membrane loses water while in the hot press, the Tg moves back up to near dry membrane Tg. The stainless steel plates apply uniform pressure and allow water to escape to the cloth which acts like an absorbent. The membrane surfaces make contact with the stainless steel plates, not the cloth.

The DSICL does not swell in the X and Y plane (surface plane) but does swell in the Z (normal to surface) plane. This DSICL exhibits higher conductivities and water uptake along with increased Z/X ratio for swelling, as shown in Table 2 below. The table shows comparison of a standard ICL made from the random copolymer of Formula IV with the DSICL made from the same polymer.

TABLE 2

| | Standard DMFC (PFI) | Oriented Polymer (OP) |
|---|---|---|
| Property | Membrane | Membrane |
| Swelling in X | 9.2 | 4 |
| Swelling in XY (area) | 19.2 | 8.2 |
| Swelling in Z | 23 | 45.4 |
| Anisotropy Ratio Z/X | ~2.5 | 11.4 |
| Conductivity (S/cm) | ~0.032 | 0.051 |
| Water uptake (% wt) | 24 | 45.5 |

Example 3

An ICL made from random copolymer, formula IV, 5 cm×5 cm is swollen in methanol-water solution, 85% methanol by weight, for 16 hours, followed by a DI (de-ionized) water soak for 30 minutes with change in water every 10 minutes. The ICL is then hot pressed at 150° C. with pressure of 10 kg/cm2 for 45 seconds. The resulting DSICL swells anisotropically once exposed to solvent/water solutions. In 85 wt % methanol/water solution the DSICL swells <8% in X^{M} and Y^{M} dimension and swells 86% in the Z^{M} dimension.

### Example 4

An ICL made from random copolymer, formula IV, 5 cm×5 cm is swollen in methanol-water solution, 85% methanol by weight, for 16 hours, followed by a DI (de-ionized) water soak for 30 minutes with change in water every 10 minutes. The ICL is then hot pressed at 120° C.-170° C. with pressure of 10 kg/cm2-50 kg/cm² for 15-45 seconds. The resulting DSICL swells anisotropically once exposed to solvent/water solutions. In 85 wt % methanol/water solution the DSICL swells <8% in X^{M} and Y^{M} dimension and swells 86% in the Z^{M} dimension.

### Example 5

The swelling of the anisotropic membrane is substantially reduced in the X^{M} and Y^{M} plane (surface plane) but does swell in the Z^{M} (normal to surface) plane. This anisotropic behavior, swelling principally in the Z^{M} dimension (thickness), can be achieved for other PEMs from other polymer families particularly polymers with aromatic rings in the backbone structure. The anisotropic membrane exhibits higher conductivities and water uptake along with increased Z^{M}/X^{M} ratio for swelling, as shown in Table 3 below. The table shows comparison of standard DMFC membrane made from the random copolymer of Formula IV with the anisotropic membrane made from the same polymer. Comparison of anisotropic membrane to its parent standard membrane (prepared according to Example 1, 2, 3, 4, and 5) once soaked in 85 wt % methanol (in methanol water solution) at room temperature.

TABLE 3

| | Standard DMFC | |
|---|---|---|
| | (Polyfuel Inc.) | |
| Property | Membrane | Anisotropic Membrane |
| Swelling in X^{M} | 1 | ¼ |
| Swelling in X^{M}Y^{M} (area) | 1 | ¼ |
| Swelling in Z^{M} | 1 | 3 |
| Anisotropy Ratio Z^{M}/X^{M} | 1 | 11.6 |
| Conductivity (S/cm) | 1 | 1 |
| Water content (% volume) | 1 | 1.1 |

### Example 6

A 5 cm×5 cm membrane, made from the random copolymer of formula IV, was first swollen in methanol-water solution (85% methanol by weight) for 16 hours, followed by a DI (de-ionized) water soak for 30 minutes with a change in water every 10 minutes. The washed membrane was then restrained in a tenter frame such as that shown in FIG. 3 and dried (100° C.). The swollen state of the membrane can also be achieved by washing the cast PEM high levels of casting solvent.

### Example 7

A 5 cm×5 cm membrane, made from the random copolymer of formula IV, was first swollen in methanol-water solution, 85% methanol by weight, for 16 hours, followed by a DI (de-ionized) water soak for 30 minutes with change in water every 10 minutes. The washed membrane is then restrained in a tenter frame and dried at 40° C. to 140° C., shown in FIG. 3. The swollen state of the membrane can also be achieved by washing the cast PEM at high casting solvent levels.

### Example 8

A membrane made from a random copolymer 5 cm×5 cm is swollen in methanol-water solution, 85% methanol by weight, for 16 hours, followed by a DI (de-ionized) water soak for 30 minutes with change in water every 10 minutes. The membrane is then placed between “stack” shown in FIG. 2, and hot pressed at 150° C. with pressure of 10 kg/cm2 for 45 seconds. the resulting membrane swells anisotropically once exposed to solvent/water solutions. In 85 wt % Methanol/water solution the membrane swells <8% in X^{M} and Y^{M} dimension and swells 86% in the Z^{M} dimension.

### Example 9

A membrane made from a random copolymer 5 cm×5 cm is first swollen, in methanol-water solution, 85% methanol by weight, for 16 hours, followed by a DI (de-ionized) water soak for 30 minutes with change in water every 10 minutes. The washed membrane is then restrained in a tenter frame and dried (100° C.) shown in FIG. 10. The swollen state of the membrane can also be achieved by washing the cast PEM at high casting solvent levels.

### Example 10

A polymer of Formula IV is dissolved in N,N-dimethylacetamide, coated onto PET, and dried to a solvent residue of 17% by weight. The 5 cm×5 cm piece of this membrane is then heated in an oven at 100 C and stretched in the X^{M} dimension to approximately 175% its original length in that dimension. The membrane sample is then washed in water at room temperature for 16 hours and then dried. A dried sample of this membrane is then swelled in 85 wt. % MeOH for 1 hour and then washed with water. The swelling of this membrane is determined to be 2% in the X^{M} dimension, 19% in the Y^{M} dimension and 57% in the Z^{M} dimension.

### Example 11

A polymer of Formula IV was dissolved in N,N-dimethylacetamide, coated onto a PET backing and dried with hot air to a solvent residue of 10-20% by weight. A piece of the resulting membrane was removed from the PET backing and mechanically stretched to about 180% of its original length. The piece was cut in two, arranged in an overlapping manner such that the direction of stretch of the two pieces was at 90° to each other and subjected to heat and pressure (120° C. for 3 min at a pressure of 1000 kg/cm²) such that the pieces were laminated together. The membrane had some residual solvent (DMAc) that helped plastercize the interface to create a bonded/laminated membrane. A washed and dried sample of this membrane was then swelled in 85 wt. % MeOH for 16 hours and then washed with water. The swelling of this membrane was determined to be 12% in the X^{M} dimension, 11% in the Y^{M} dimension and 42% in the Z^{M} dimension.

### Example 12

A polymer of Formula IV was dissolved in N,N-dimethylacetamide, coated onto PET, and dried to a solvent residue of 17% by weight. The 5 cm×5 cm piece of this membrane was then heated in an oven at 100° C. for 5 minutes, removed from the PET backing and stretched in the X^{M} dimension to approximately 175% its original length in that dimension. While still in an oven at 100° C., this sample was stretched in the Y^{M} dimension to approximately 175% its original length in that dimension. The membrane sample was then washed in water at room temperature for 16 hours and then dried. A dried sample of this membrane was then swelled in 85 wt. % MeOH for 1 hour and then washed with water. The swelling of this membrane was determined to be 2% in the X^{M} dimension, 2% in the Y^{M} dimension and 90% in the Z^{M} dimension.

### Example 13

A polymer of Formula IV is dissolved in N,N-dimethylacetamide, coated onto PET, and dried with hot air to a solvent residue of 10-20% by weight. A 15 cm×15 cm piece of this membrane was peeled off the PET film and spliced in the middle of a PET web and transported through an 1 meter oven at 110° C. at 0.2 m/min. Tension was adjusted with a machine having unwind and wind capabilities. The unwind tension was increased to achieve the desired “draw” to achieve stretching of 170% of its original length in that dimension. The membrane was removed from the web, rotated 90° and re-spliced. The membrane was stretched again to 170% of its original length in that dimension. It was removed from the web, washed in water at room temperature for 16 hours and then dried. A dried sample of this membrane was then swelled in 50 wt. % MeOH for 16 hours and then washed with water. The swelling of this membrane was determined to be 9% in the X^{M} dimension, 9% in the Y^{M} dimension and 37% in the Z^{M} dimension. It had a proton conductivity of 0.038 S/cm².

### Example 14

A piece of membrane cast from a polymer of formula IV was thoroughly equilibrated at room temperature and relative humidity then stretched mechanically to about 150% of it's original length only in the X^{M} direction. The sample was then dried and subsequently soaked in 85% methanol overnight then washed in water. The swelling of this membrane in 85% methanol-water was determined to be −5% in the X^{M} dimension (shrinkage in the X^{M} direction), 39% in the Y^{M} dimension and 38% in the Z^{M} dimension. It had a proton conductivity of 0.057 S/cm².

### Example 15

A polymer of Formula IV was dissolved in N,N-dimethylacetamide, coated onto PET, and dried with hot air to a solvent residue of 10-20% by weight. A piece of the resulting membrane was mechanically stretched to about 180% of its original length. The piece was cut in two, arranged in an overlapping manner such that the direction of stretch of the two pieces was at 90° to each other and subjected to heat and pressure (˜1000 kg/cm2, for 3 min. at 120° C.) such that the pieces were laminated together. A washed and dried sample of this membrane was then swelled in 85 wt. % MeOH for 16 hours and then washed with water. The swelling of this membrane was determined to be 12% in the X^{M} dimension, 11% in the Y^{M} dimension and 42% in the Z^{M} dimension.

### Example 16

Nafion (N115) can be stabilized to swell anisotropically via the restrain/dry process in a hot-press. Nafion 115 was swelled in 85% MeOH (wt %) and the hot pressed at 150° C. for 1 minute with ˜50 kg/cm2 pressure applied. The membrane thus formed shrinks if exposed to temperatures >80° C. However, if the Nafion is hydrated, it swells 1 to 3% in X^{M} or Y^{M} and 54% in Z^{M}. We found that Nafion must be hot pressed above 120° C. to produce this stability. The difference in X and Y swelling is because the Nafion membrane is slightly uniaxially oriented (possibly a side effect of extruding).

The following table sets forth the sulfonation degree for polymers made from the ion-conducting polymer of Formula IV as used in Examples 17-27.

TABLE 1
Correlation of Sulfonation and Polymer ID

| Sulfonation (x) | Polymer ID |
|---|---|
| 0.15 | Polymer 1 |
| 0.25 | Polymer 2 |
| 0.30 | Polymer 3 |
| 0.50 | Polymer 4 |

### Example 17

A 5% solution of Polymer 1 in cyclopentanone is rod-coated onto Mylar using a #6 rod. A 8 cm×8 cm square of this coating is cut out.

A solution of Polymer 3 in DMAc is coated onto Mylar to a dry thickness of 10 um. Two 10 cm×10 cm squares of this coating are cut out.

The coating of Polymer 1 is pressed onto the 10 um coating of Polymer 3 at 150 C, 2500 lbs for 3 minutes and its underlying Mylar film is removed, as in FIG. 12A. The second 10 cm×10 cm piece of Polymer 3 on Mylar is laminated under the identical conditions onto the top of the bilayer structure created in the first step as in FIG. 12B. The Mylar is removed from both sides and the membrane is washed in DI water. The final dried product is a multilayer composite membrane having different IEC's in adjacent layer.

### Example 18

A multilayer composite membrane is prepared as in Example 17 except that the 5% solution of Polymer 1 in cyclopentanone is rodcoated using Rod #12.

### Example 19

A multilayer composite membrane is prepared as in Example 17 except that the 5% solution of Polymer 1 in dimethylacetamide is rodcoated using Rod #6.

### Example 20

A 5% solution of Polymer 1 in cyclopentanone is rod-coated onto Mylar using a #6 rod. A 8 cm×8 cm square of this coating is cut out.

A 10 um membrane composed of Polymer 3 is soaked in 85% MeOH for 24 hours, rinsed in water for 24 hours, and then pressed between two perforated metal sheets at 150 C for 15 seconds to create a dimensionally stabilized ICL. Two 10 cm×10 cm pieces are cut out.

As in FIG. 12A: The coating of Polymer 1 on Mylar is pressed onto the DSICL at 150 C, 10000 lbs for 3 minutes. The mylar is removed. The second 10 cm×10 cm piece of DSICL is pressed to the bilayer laminated membrane to produce a multilayer composite membrane.

### Example 21

A multilayer composite membrane is prepared as in Example 20, except that the 10 um membrane is Polymer 3 is soaked in 60% 2-ethoxyethanol prior to the biaxial orientation step.

### Example 22

A multilayer composite membrane is prepared as in Example 21, except that the DSICL's are prepared from membranes composed of Polymer 2 and that it is a 5% solution of Polymer 3 in cyclopentanone that is coated on Mylar.

### Example 23

A multilayer composite membrane is prepared as in Example 22, except that it is a 5% solution of Polymer 4 in cyclopentanone that is coated on Mylar.

### Example 24

A multilayer composite membrane is prepared as in Example 23 except that the 5% solution of Polymer 4 in dimethylacetamide is rodcoated using Rod #6.

### Example 25

A multilayer composite membrane is prepared as in Example 23 except that the 5% solution of Polymer 4 in cyclopentanone is rodcoated using Rod #12.

### Example 26

A multilayer composite membrane is prepared as in Example 23 except that the DSICL's are prepared from 15 um membranes composed of Polymer 2.

### Example 27

A multilayer composite membrane is prepared as in Example 26 except that the 5% solution of Polymer 4 in dimethylacetamide is rodcoated using Rod #12.

Results

The cell resistance (Cell R) and methanol crossover (XO) at 66° C. for the composite membranes of Examples 17-27 are set forth in Table 2. “Control” refers to non-composite PEMs composed of Polymer 3 of varying thicknesses.

| Example | | Control | | Composite PEM | |
|---|---|---|---|---|---|
| Number | Thickness in Microns | Cell R | XO | Cell R | XO |
| Example 17 | 21 | | | 0.11 | 83 |
| Example 18 | 22 | | | 0.12 | 71 |
| Example 19 | 21 | | | 0.135 | 75 |
| Example 20 | 21 | | | 0.21 | 51 |
| Example 21 | 21 | | | 0.18 | 53 |
| Example 22 | 21 | | | 0.115 | 67 |
| Example 23 | 21 | | | 0.10 | 63 |
| Example 24 | 21 | | | 0.11 | 77 |
| Example 25 | 22 | | | 0.125 | 66 |
| Example 26 | 31 | | | 0.138 | 57 |
| Example 27 | 32 | | | 0.15 | 48 |
| Control | 20 um | 0.1 | 106 | | |
| Control2 | 20 um | 0.09 | 144 | | |
| Control | 30 um | 0.13 | 87 | | |
| Control2 | 30 um | 0.13 | 88 | | |
| Control | 45 um | 0.18 | 59 | | |
| Control2 | 45 um | 0.16 | 60 | | |
| Control | 62 um | 0.22 | 42 | | |
| Control2 | 62 um | 0.24 | 36 | | |

| | 2 outer layers | | | | Inner layer | | | | Total |
|---|---|---|---|---|---|---|---|---|---|
| | | | | Pre-DS | | | | Approx. | Approx. |
| Example | Polymer | Thickness | DS? | Soak | Polymer | Solvent | Rod# | Thickness | Thickness |
| 17 | 3 | 10 | No | n/a | 1 | CP | 6 | 1 | 21 |
| 18 | 3 | 10 | No | n/a | 1 | CP | 12 | 2 | 22 |
| 19 | 3 | 10 | No | n/a | 1 | DMAc | 6 | 1 | 21 |
| 20 | 3 | 10 | Yes | 85% MeOH | 1 | CP | 6 | 1 | 21 |
| 21 | 3 | 10 | Yes | 60% EOE | 1 | CP | 6 | 1 | 21 |
| 22 | 2 | 10 | Yes | 60% EOE | 3 | CP | 6 | 1 | 21 |
| 23 | 2 | 10 | Yes | 60% EOE | 4 | CP | 6 | 1 | 21 |
| 24 | 2 | 10 | Yes | 60% EOE | 4 | DMAc | 6 | 1 | 21 |
| 25 | 2 | 10 | Yes | 60% EOE | 4 | CP | 12 | 2 | 22 |
| 26 | 2 | 15 | Yes | 60% EOE | 4 | DMAc | 6 | 1 | 31 |
| 27 | 2 | 15 | Yes | 60% EOE | 4 | DMAc | 12 | 2 | 32 |

(CP = cyclopentanone; DMAc = dimethylacetamide; EOE = 2-ethoxyethanol)

What is claimed is:

1. A composite polymer electrolyte membrane (PEM) comprising first and second ion-conducting layers, where said composite PEM is defined by dimensions X^{M} and Y^{M} and a thickness Z in the Z^{M} dimension perpendicular to an X^{M}, Y^{M} plane and where said first layer comprises a dimensionally stabilized ion-conducting layer (DSICL) that swells anisotropically in the Z^{M} dimension as compared to its swelling in the X^{M} and/or Y^{M} dimension.

2. The composite PEM of claim 1 further comprising a third layer, where said third layer comprises a DSICL and is in contact with said second layer.

3. The composite PEM of claim 1 or 2 where Z is between 20 and 65 microns.

4. The composite PEM of claim 1 or 2 wherein said second layer has a thickness of 5 microns or less.

5. The composite PEM of claim 1 or 2 wherein said second layer has a thickness from 1 to 2 microns.

6. The composite PEM of claim 2 further comprising a fourth ion-conducting layer, where said fourth layer is in contact with said third layer.

7. The composite PEM of claim 6 further comprising a fifth layer in contact with said fourth layer, where said fifth layer comprises a DSICL.

8. A composite electrolyte membrane (PEM) comprising in order first, second, and third ion-conducting layers, where said PEM is defined by dimensions X^{M} and Y^{M} and a thickness Z in the Z^{M} dimension perpendicular to an X^{M}, Y^{M} plane and where said second layer is a dimensionally stabilized ion-conducting layer (DSICL) that swells anisotropically in the Z^{M} dimension as compared to its swelling in the X^{M} and/or Y^{M} dimension.

9. The composite PEM of claims 1-8 where at least one of the ion-conducting or dimensionally stabilized ion-conducting layers has a lower ion exchange capacity (IEC) than at least one of the other layers.

10. The composite PEM of claim 9 where at least one of said second and fourth layers has a lower IEC.

11. The composite PEM of claim 9 where at least one of said first, third and fifth layers has a lower IEC.

12. A composite polymer electrolyte membrane (composite PEM) comprising first and second layers in contact with each other where such 1st and 2nd layer each comprising an ion-conducting polymer, where said second layer has thickness less than 5 microns and a lower ion exchange capacity (IEC) than said first layer.

13. The composite polymer of claim 12 where the ion conducting polymers of such first and second layers are not sulfonated poly (ether ether ketone) (sPEEK); sulfonated poly (either ketone) (sPEK); polybenzimidazole (PBI) or a perfluorinated sulfonic acid aliphate-polymer or copolymer.

14. The composite PEM of claim 12 wherein said first layer has a thickness of 30 microns or less.

15. The composite PEM of claim 12 further comprising a third layer comprising an ion-conducting polymer, where said second layer is between said first and said third layers.

16. The composite PEM of claim 15 wherein the thickness of said composite PEM is less than 50 microns.

17. A composite polymer electrolyte membrane (composite PEM) comprising first and second layers each comprising an ion-conducting polymer, where said first layer has an ion exchange capacity (IEC) greater that the IEC of said second layer, and where the ion conducting polymers of such first and second layers are not sulfonated poly (ether ether ketone) (sPEEK); sulfonated poly (either ketone) (sPEK);
polybenzimidazole (PBI) or a perfluorinated sulfonic acid aliphate-polymer or copolymer.

18. The composite PEM of claim 17 further comprising a third layer comprising an ion-conducting polymer, where said third layer is said second layer and has an IEC greater than the IEC of said second layer.

19. A catalyst coated membrane (CCM) comprising the composite PEM of claims 1-18 and a catalyst layer, where said composite PEM has first and second surfaces defined by dimensions X^{M} and Y^{M} and where said catalyst layer is parallel to said first surface.

20. The CCM of claim 19 further comprising a second catalyst layer parallel to said second surface.

21. A membrane electrode assembly comprising the composite PEM of claims 1-17.

22. A fuel cell comprising the composite PEM of claims 1-17.

23. An electronic device comprising the fuel cell of claim 22.

24. A power supply comprising the fuel cell of claim 22.

25. An electric motor comprising the fuel cell of claim 22.

26. A vehicle comprising the fuel cell of claim 22.
